(19) United States
(12) Patent Application Publication
(10) Pub. No.: US 2024/0198621 A1
(43) Pub. Date: Jun. 20, 2024

(54) Device and Method for the Production of Bags from Pieces of Tube

(71) Applicant: STARLINGER & CO GESELLSCHAFT M.B.H., Wien (AT)

(72) Inventor: Herbert FÜRST, Bad Vöslau (AT)

(21) Appl. No.: 18/556,974

(22) PCT Filed: Mar. 9, 2022
(86) PCT No.: PCT/AT2022/060066

§ 371 Date: Oct. 24, 2023

(30) Foreign Application Priority Data
Apr. 29, 2021 (AT) A 50321/2021

(51) Int. Cl. B31B 70/02; B31B 70/00; B31B 70/04; B31B 150/00; B31B 160/20

(52) U.S. Cl. CPC B31B 70/022; B31B 70/006; B31B 70/04; B31B 2150/0014; B31B 2150/003; B31B 2160/20

(57) ABSTRACT

A transport device of the device for the production of bags from pieces of tube transports the pieces of tube. In doing so, the pieces of tube pass through processing for the formation of cross bottoms. A transfer device transfers the pieces of tube consecutively to the transport device so that the rear side edge of one piece of tube is always at a distance from the front side edge of the subsequent piece of tube. Retaining elements are arranged on a transport chain at a defined distance. Depending on the width of the pieces of tube and the defined spacing of the retaining elements, the distance between the pieces of tube is adjusted in such a way that, during the transport of the pieces of tube, the retaining elements always assume the same positions relative to the front side edge of each piece of tube, independently of the width of the pieces of tube.

The invention relates to a device and a method for the production of cross-bottom bags from pieces of tube, the pieces of tube preferably being manufactured from a fabric made of plastic tapes or a nonwoven plastic material (e.g., a plastic fleece) or a composite made of the fabric made of plastic tapes and the nonwoven plastic material or a plastic film optionally connected to a network structure, with the material optionally being coated on at least one side with at least one plastic layer and optionally with at least one plastic film, e.g., an OPP film. The pieces of tube are transported, while lying flat on a transport device, in a transport direction transversely to their longitudinal extension at a transport speed, with the pieces of tube passing through processing stations during their transport, by means of which at least one end region of each piece of tube is formed into a cross bottom. A cover sheet is usually applied to the cross bottom that has been formed.

Box bags, also known as cross-bottom bags, are bags of a cuboid shape which are manufactured in bag conversion lines in that pieces of tube are provided whose open end regions are folded to form cross bottoms. The pieces of tube are guided through the conversion line in a state of lying flat so that two layers of the piece of tube will abut each other. For the formation of the bottom, the two layers are separated from each other at the end regions of the piece of tube, and one of the two layers is folded over onto itself by 180° as a side flap, whereby an open bottom is created in which the other layer forms a second side flap. By folding over a layer at the end region of the piece of tube, a triangular corner fold is created at the front and rear parts of this end region, respectively. In technical language, this process is also referred to as “drawing up”. In a further processing sequence, valve sheets can be inserted (in order to produce “box valve bags” which can be filled through the valve using fill nozzles), and the final bottom configuration is generated by folding in the bottom side flaps in a manner so that they overlap each other. The overlapping bottom side flaps are glued or thermally welded together depending on the material of the piece of tube. As an alternative or in addition, bottom cover sheets can be placed on the overlapped bottom side flaps and can be glued or welded to them. Such a bag conversion line is described in patent AT 408 427 B.

The throughput of bag conversion lines largely depends on the transport speed at which the tubular sections to be manufactured are transported through the conversion line. The cyclic operation of the bag conversion line known from patent AT 408 427 B has turned out to be a disadvantage of said line, which limits the throughput of pieces of tube to be processed. The time required for drawing up the bottoms in a clocked manner, including the necessary fixation of the drawn-up bottoms, can even constitute an upper limit for the performance of the entire device for the production of bags.

This disadvantage has been overcome by the device for the formation of open bottoms on pieces of tube as disclosed in EP 2 441 574 B1, which allows the pieces of tube to be conveyed continuously, which has resulted in an increase in transport speed and productivity.

The transport speed of pieces of tube in bag conversion lines could be increased further by the invention described in EP 2 711 166 A1, by means of which the clock frequency of a workpiece holder was increased in the transfer area of pieces of tube from their longitudinal transport to their transverse transport.

The limits of the performance of devices for the formation of the cross bottoms, which are arranged along the transport path of the pieces of tube, in particular of hot-air welding devices for attaching bottom cover sheets and/or valves to the pieces of tube, have meanwhile been reached with the increase in transport speed. Therefore, an increase in the throughput of bag conversion lines cannot be achieved by further increasing the transport speed of the pieces of tube.

From the European patent EP 3041671 B1, a method and a device for the production of cross-bottom bags from pieces of tube are known, which provide a solution for increasing the clock frequency without having to increase the transport speed of the transport device on which the pieces of tube are transported while lying transversely. This solution consists in providing a method and a device for the production of cross-bottom bags from pieces of tube with a selectable width Bi, in which the pieces of tube are transported on a transport device continuously along a transport path in a transport direction x, which runs transversely to the extension direction z and in parallel to the width direction of the pieces of tube. A bottom opening station for placing an open cross bottom is arranged along the transport device. A transfer device transfers the pieces of tube to the transport device. There are adjustment means by means of which the device is adjusted depending on the width Bi of the pieces of tube in such a way that the pieces of tube are arranged and processed on the transport device at a mutual distance A which is independent of the width of the pieces of tube, with at least one component of the device having a tool which is brought into contact with the pieces of tube for transferring and processing them, wherein the time interval between the times at which the at least one tool comes into contact with consecutive pieces of tube is adjustable depending on the width Bi of the pieces of tube.

The core of the invention described in EP 3041671 B1 is thus considered to be the fact that the transfer and processing of the pieces of tube is varied depending on the width Bi of the pieces of tube in such a way that the pieces of tube on the transport device are arranged and processed at a distance A from each other that is independent of the width Bi of the pieces of tube. As a result, a significant increase in efficiency is supposed to be achievable, especially when processing pieces of tube having a width Bi that is significantly smaller than the maximum tube width which can be processed, see paragraph [0012].

However, what may sound obvious at first glance turns out to be afflicted with serious problems in practice, since the freedom to select the width Bi of the pieces of tube and their spacing A on the transport device actually significantly affects the transport of the pieces of tube and their processing into cross-bottom bags so that, if the bag conversion line has a high cycle rate, cross-bottom bags of diminished quality are produced, or the cycle rate and thus the output of the machine must be reduced in order to achieve a high quality of the bags.

On the one hand, such problems which arise in practice when the width Bi of the pieces of tube and their spacing A on the transport device can be freely selected always occur if the transport device has discrete retaining elements, such as magnets, suction cups, etc., which are arranged on a transport chain or a conveyor belt at defined distances from each other in order to retain the front side edges of the pieces of tube during their transport. However, such retaining elements are indispensable for the desired high transport speeds, since otherwise the lack of flatness caused by an excessive projecting length of the front bag edge and consequently the increased frictional resistance during the transport and processing of the pieces of tube, e.g., when arranging, folding over, disrupts the production of bags in the bag conversion line. Large projecting lengths in combination with a lack of flatness and air resistance can cause pieces of tube to get stuck on fixed guide elements or tools (e.g., folding and guide strips), to be bent over or to be displaced. However, the freedom to select the width Bi of the pieces of tube and their spacing A on the transport device has the effect that the position of the front side edge of each piece of tube also changes arbitrarily with respect to the retaining element. On the one hand, this can mean that the front edges are gripped only partially by the retaining elements, which is disastrous especially in case of suction cups, since a suction effect is no longer achievable. But also with other retaining elements, such as magnets, the fact that the front side area is gripped only partially and, as a result, the pieces of tube are fixed insufficiently can cause them to be torn out of their clamping due to the frictional resistance during transport and processing and/or can cause a tilt (a skew position) of the magnets and consequently a decrease in the clamping force as a result of the support which is not over the entire surface. If, on the other hand, the freedom to select the width B of the pieces of tube and their spacing A causes the front side edges of the pieces of tube to exceed a tolerable amount of projecting length in the transport direction relative to the retaining elements (and this projecting length can be between zero and the entire free path length between two adjacent retaining elements), the flatness of the piece of tube becomes insufficient due to the large projecting length of the bag's front edge, whereby the frictional resistance during the transport and processing of the pieces of tube increases and the production of bags is disrupted. Large projecting lengths in combination with a lack of flatness and air resistance can cause pieces of tube to get stuck on fixed guide elements or tools (e.g., folding and guide strips), to be bent over or to be displaced. In both cases as described, geometrically correct processing of the pieces of tube is not possible, which results in an increase in the reject rate. In addition, it may happen that workpieces that have been bent over and, as a result, have been jammed cause a machine shutdown. In the worst case, the bag manufacturing plant is thereby damaged.

In bag manufacturing plants for cross-bottom bags, apart from the retaining elements, there can also be processing elements which are also arranged at defined spatial distances from each other and operate in a timed manner. With all such processing elements, the freedom to select the width Bi of the pieces of tube and their spacing A on the transport device likewise constitutes a problem, because, of course, it is true also for such processing elements that the position of the front side edge of each piece of tube with respect to the processing elements changes depending on the setting of width B of the pieces of tube and their distance A from each other.

Further problems associated with the freedom to select the width Bi of the pieces of tube and their spacing A on the transport device arise during the production of cross-bottom bags with valves, especially in case of bags with an extended valve that projects laterally above the edges of the pieces of tube. EP 3041671 B1 also completely ignores the fact that there is a correlation between the system length, which is the width of a piece of tube plus its distance from the previous piece of tube on the transport device, and the bag bottom widths of the cross-bottom bags which can be produced (and can be ordered by the buyer or, respectively, the user of the produced bags).

Thus, there is still demand for a device and a method for the production of cross-bottom bags which overcome the above-described problems of the prior art and allow the contact between the pieces of tube and the retaining elements and/or processing elements to be precisely and uniformly adjusted and adhered to in a geometric relation to one another in order to thereby prevent the rejection of low-quality cross-bottom bags and unplanned machine shutdowns.

The present invention achieves the object that has been presented by providing a device for the production of cross-bottom bags having the features of claim 1 and by a method for the production of cross-bottom bags having the features of claim 11. Advantageous embodiments of the invention are set forth in the dependent claims and in the specification.

The device according to the invention and, respectively, the method according to the invention for the production of bags from pieces of tube are excellently suitable for processing pieces of tube made of a fabric made of plastic tapes or a nonwoven plastic material (e.g., a plastic fleece) or a composite made of the fabric made of plastic tapes and the nonwoven plastic material or a plastic film optionally connected to a network structure, with the material optionally being coated on at least one side with at least one plastic layer and optionally with at least one plastic film, e.g., an OPP film.

Pieces of tube to be transported are transported, while lying flat, in a transport direction transversely to their longitudinal extension at a transport speed, with the pieces of tube passing through processing stations during their transport, by means of which at least one end region of each piece of tube is formed into a cross bottom. In addition, a cover sheet is usually applied to the cross bottom that has been formed in order to increase the strength of the bottom.

By means of a transfer device, the pieces of tube are transferred consecutively to the transport device transversely to their longitudinal extension so that the rear side edge of one piece of tube is always at a distance from the front side edge of the subsequent piece of tube.

In the device according to the invention, the transport device has at least one transport chain or a conveyor belt on which retaining elements are arranged at a defined distance from each other, this defined distance being the same for all adjacent retaining elements. According to the invention, the distance between the pieces of tube is adjusted depending on the width of the pieces of tube and the defined spacing of the retaining elements in such a way that—viewed in the transport direction—during the transport of the pieces of tube, the retaining elements always assume the same predetermined positions relative to the front side edge of each piece of tube, independently of the width of the pieces of tube. In this way, it is ensured that the pieces of tube, especially in the area of their front side edge, are securely gripped by the retaining elements and are retained during transport so that not even the air resistance displaces or bends the pieces of tube or actually tears them out of their clamping. As a result, the pieces of tube lie in the bag conversion line with optimum flatness, the frictional resistance during transport and processing in the bag conversion line is minimal, and the pieces of tube cannot get stuck on fixed guide elements or tools, bent over or displaced.

In a preferred embodiment of the device according to the invention, the device comprises a control for controlling the transfer device and for determining a system length, which is the sum of the width of a piece of tube and its distance from the subsequent piece of tube. The control has computing means which calculate the system length as an integer multiple of the defined distance between the retaining elements and, based on the calculated system length and the width of the pieces of tube, adjust the distance at which the transfer device transfers the pieces of tube consecutively to the transport device.

The nominal width of the pieces of tube of a batch does not change during the operation of the bag conversion line and is entered manually by an operator prior to the start-up of the bag conversion line, using input means such as a keyboard, a touchscreen, or the like. Alternatively, a width sensor can be provided which automatically detects the nominal width of the pieces of tube, wherein, also in this case, continuous width measurement is not required since all pieces of tube supplied from a tube roll have the same nominal width.

In practice, minor fluctuations in the actual tube widths (i.e., deviations from the entered nominal width) occur due to production, but these are within the permissible tolerances. In order to take into account also these fluctuations in the actual tube widths, it is envisaged in a further embodiment according to the invention that the actual tube width is detected continuously with a sensor and the system length is calculated for each piece of tube as an integer multiple of the distance between the retaining elements. As a result, both production-related fluctuations in the actual tube width within a tube batch and a change in width during the exchange of the tube roll can be taken into account.

The term “width” is understood to mean the “nominal width” of the pieces of tube, unless explanations to the contrary in this document allow a deviation therefrom or the contents imply a different outcome.

The distance between the retaining elements is a predefined design feature of the device according to the invention. Due to material stress and the resulting wear elongation of the means of transport, in particular the transport chains or conveyor belts, it may happen that the distance between the retaining elements changes over time. In order to compensate for this change, in a preferred embodiment of the invention a sensor is provided which measures the wear elongation and adjusts the spacing of the retaining elements, which is used for the calculation, by multiplying the predefined distance between the retaining elements by a correction factor corresponding to the wear elongation. This corrected spacing of the retaining elements is then used for further calculations of the system lengths. As a result, during the transport of the pieces of tube, the retaining elements continue to always assume the same predetermined positions relative to the front side edge of each piece of tube, independently of the width of the pieces of tube.

In a preferred embodiment of the invention, the control determines the system length in such a way that a minimum distance between the successive pieces of tube is not fallen short of when they are transported on the transport device. The specified minimum distance can be due to technical demands made on the bag conversion line and/or a desired bottom width of the bags to be produced. However, it can also be determined based on the length of the valves of the bags, namely if valves are used which project above one of the side edges of the pieces of tube.

In an appropriate embodiment of the invention, the computing means of the control calculate the system length as follows:
adding the width of the pieces of tube and a minimum distance to be maintained between successive pieces of tube to a temporary system length,
dividing the temporary system length by the defined distance between the retaining elements,
rounding up the division result to the next higher integer and multiplying the next higher integer determined in this way by the defined distance between the retaining elements.

Due to the design, a minimum system length can be defined in the device according to the invention, which minimum system length must not be fallen short of for smooth operation of the device. Therefore, in one embodiment of the invention, it is envisaged that the computing means of the control compare the calculated system length with a minimum system length and, if the comparison shows that the system length is smaller than the minimum system length, establish the system length as the minimum system length, with the minimum system length being an integer multiple of the defined distance between the retaining elements.

It may also be envisaged in the invention that an operator can increase the calculated system length by an integer multiple of the defined distance between the retaining elements through user input in order to be able to respond to production-specific demands.

To ensure a safe operating mode and simplify the calculation processes in the device according to the invention, it may be envisaged that the width of the pieces of tube can be adjustable only in predefined increments, e.g., in increments of 5 mm.

The same inventive idea as illustrated above also forms the basis of a device and a method for the production of bags from pieces of tube having the features of the preamble of claim 1 and, respectively, claim 11, in which at least one of the processing stations comprises processing elements which are arranged at defined distances from each other and operate in a timed manner synchronously with the transport speed, wherein the distance between the pieces of tube is adjusted depending on the width of the pieces of tube and the defined distance between the processing elements in such a way that—viewed in the transport direction—during the transport of the pieces of tube, the processing elements always assume the same predetermined positions relative to the front side edge of each piece of tube, independently of the width of the pieces of tube.

The invention will now be described in further detail on the basis of exemplary embodiments, with reference to the drawings.

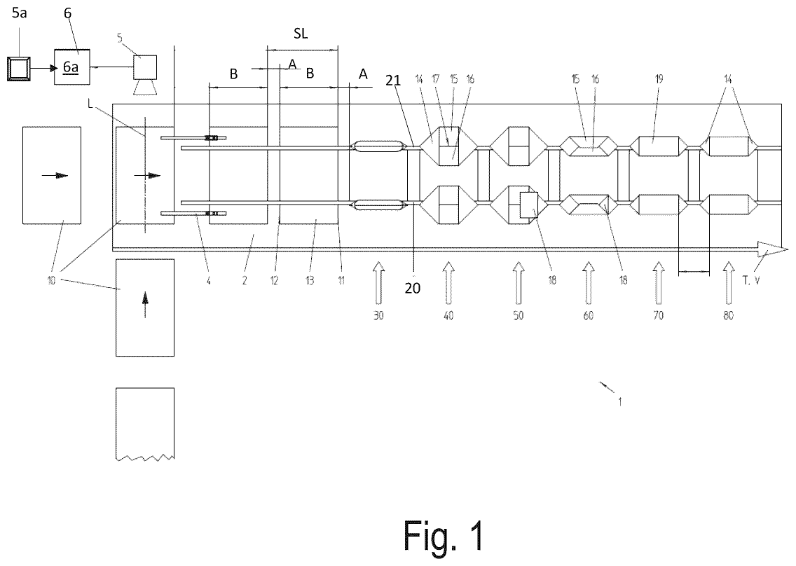

FIG. 1 shows a schematic illustration of a device for the production of cross-bottom bags from pieces of tube according to the principles of the invention.

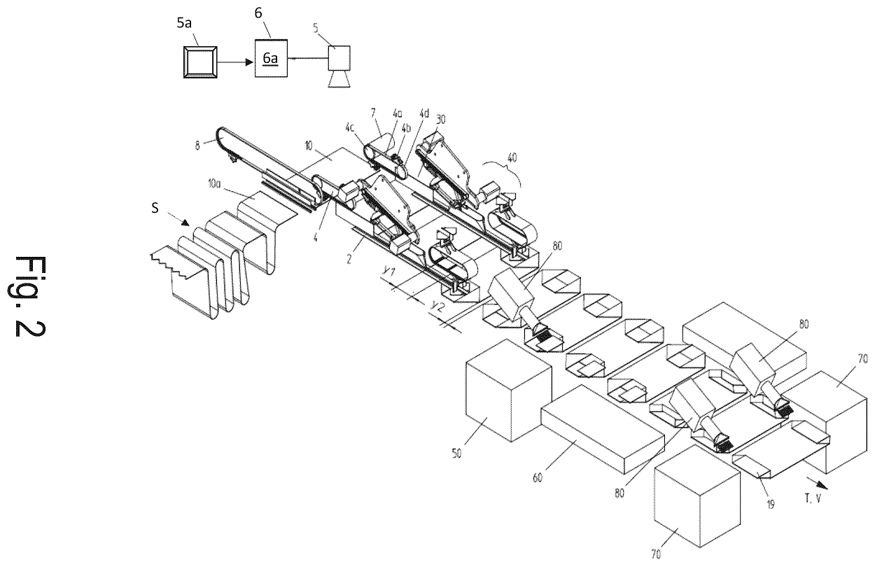

FIG. 2 shows a perspective view of a device for the production of cross-bottom bags from pieces of tube according to an embodiment of the invention.

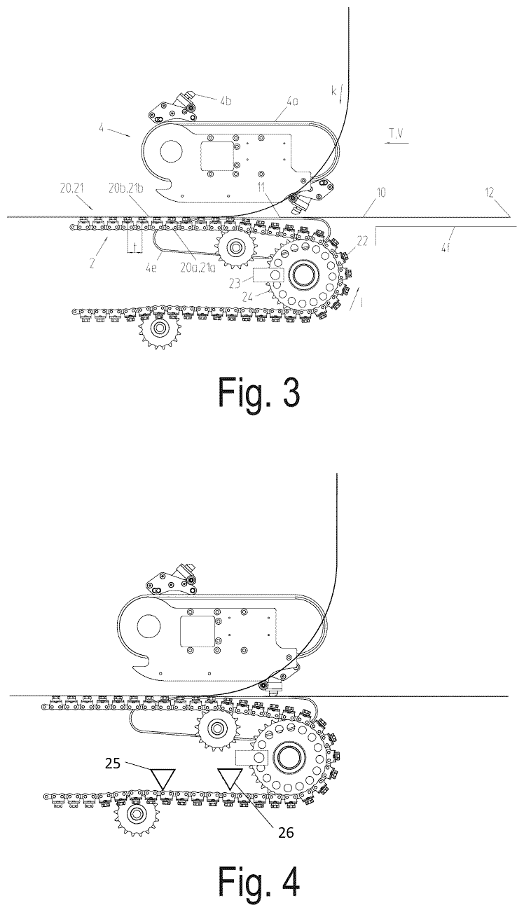

FIG. 3 shows a side view of the transfer device with a schematic illustration of the transfer of a piece of tube to the transport device at a time t₁.

FIG. 4 shows a side view of the transfer device with a schematic illustration of the transfer of a piece of tube to the transport device at a time t₂.

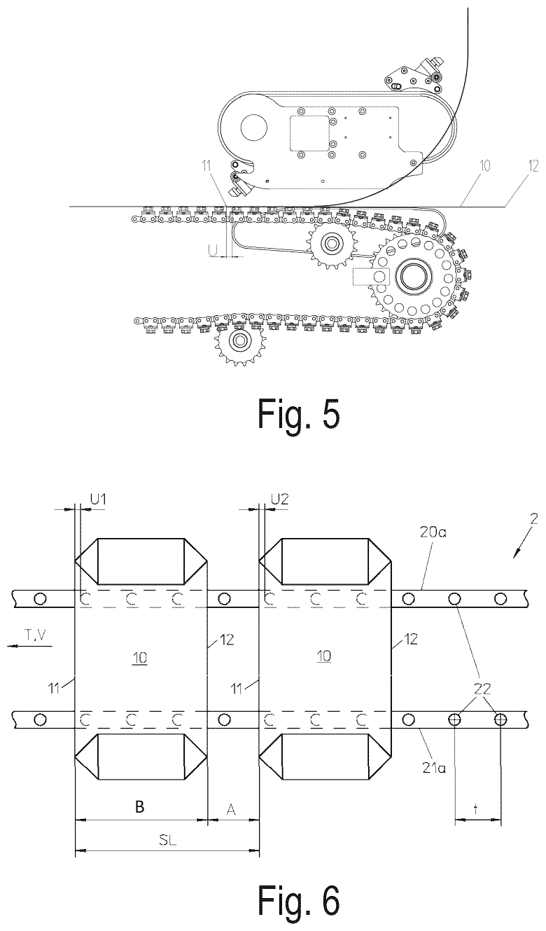

FIG. 5 shows a side view of the transfer device with a schematic illustration of the transfer of a piece of tube to the transport device at a time t₃.

FIG. 6 schematically shows a top view of two pieces of tube moving on the transport device.

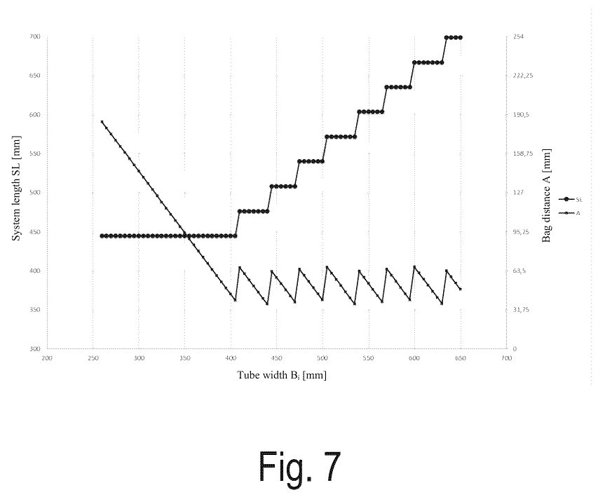

FIG. 7 shows a chart of system lengths calculated according to the invention for different widths of pieces of tube and the resulting distances between the transported pieces of tube.

With reference to FIG. 1 and FIG. 2, the principle of the device 1 according to the invention and of the method according to the invention for the production of bags from pieces of tube 10 will now be explained and described on the basis of exemplary embodiments. In the specification, the device 1 for the production of cross-bottom bags from pieces of tube is also referred to as a bag conversion line. This device 1 comprises a transport device 2 which transports the pieces of tube 10 in a state of lying flat in a transport direction T transversely to their longitudinal extension L at a transport speed V. The pieces of tube have a front side edge 11 and a rear side edge 12, between which the width B is measured. Endlessly revolving conveying means 20, 21 retain the pieces of tube 10 on the transport device 2 in the correct position. The pieces of tube 10 are manufactured from a fabric made of stretched plastic tapes or a nonwoven plastic material (e.g., a plastic fleece) or a composite made of the fabric made of plastic tapes and the nonwoven plastic material or a plastic film optionally connected to a network structure and are preferably provided with a coating made of a polymer. Composites can also comprise plastic films, paper sheets or metal foils. Optionally, the coating has a layer of OPP film, furthermore printing layers, etc.

In the embodiment of FIG. 2, a tube 10a of constant width is supplied from a storage facility, which is not illustrated, or an inline tube producing machine to a cross-cutting device 8, which cuts pieces of tube 10 from the tube 10a and supplies them to the transfer device 4, which will be described in detail below.

During their transport on the transport device 2, the pieces of tube 10 pass through processing stations 30, 40, 50, 60, 70, 80, by means of which at least one end region 13 of each piece of tube 10 is formed into a cross bottom and a cover sheet 19 is applied to the cross bottom. In the embodiment that has been outlined, the processing stations described below are designed. However, in other embodiments of the invention, not all of those processing stations are implemented, or other processing stations (quality inspection, printing device, etc.) can also be provided.

For the sake of better clarity, the processing stations are only symbolized by arrows in FIG. 1. A folding station 30 serves for folding the end regions 13 of the pieces of tube 10 upwards around the guide rails 3 from the state of lying flat. A bottom opening station 40 serves for pulling the two folded-up layers of the end regions 13 of the pieces of tube 10 away from each other, folding them over in each case by 90° in opposite directions, creating an open bottom 17 which has two side flaps 15, 16, one side flap 16 of which is folded back by 180° onto the wall of the piece of tube 10. By folding over the side flaps 15, 16, a triangular corner fold 14 is created at the front and rear parts of the open bottom 17, respectively. At a valve-sheet insertion station 50, a valve sheet 18 is placed on the open bottom 17 of the piece of tube 10 and, if necessary, is fixed by gluing or thermal welding. Subsequently, the final cross-bottom configuration is produced in a bottom forming station 60 by folding in the bottom side flaps 15, 16, whereby the triangular foldovers 14 at the front and rear bottom end regions are indeed reduced in size by being folded in, but are preserved in their triangular shape. Since the side flaps 15, 16 are folded over at fold edges that are parallel to each other, the triangular foldovers have the shape of an isosceles triangle, the hypotenuse of which runs between end points of the fold edges. If they overlap each other, the bottom side flaps 15, 16 that have been folded in are glued or thermally welded to each other, depending on the material of the piece of tube. However, there are also embodiments of bags in which the bottom side flaps 15, 16 do not overlap each other. In the illustrated embodiment, a cover-sheet application station 70 for applying a bottom cover sheet 19 to the bottom side flaps 15, 16 that have been folded in and a hot-air welding station 80 for fixing the bottom cover sheet 19 to the folded-in bottom side flaps 15, 16 are also provided. The cover-sheet application station 70 and the welding station 80 can be integrated into each other. As an alternative to the welding station 80, a gluing station can also be provided.

The device 1 comprises a transfer device 4 to which pieces of tube 10 are supplied either transversely or longitudinally. The transfer device 4 transfers the supplied pieces of tube 10 in a transverse arrangement onto the transport device 2, using a movement in the transport direction T.

As illustrated in FIG. 2, the transfer device 4 can comprise grippers 4b for gripping, retaining and releasing the pieces of tube 10. In this exemplary embodiment, the grippers 4b are attached to endless belts 4a revolving around pulleys 4c, 4d. One of the pulleys 4c is driven by a drive 7 which is (automatically) controlled by a control 6 which can also actuate the grippers 4b. As an alternative to grippers 4b, vacuum suction cups can be provided. The control 6 controls the speed of the drive 7 and controls the times at which the grippers 4b grip and release the pieces of tube 10. The control 6 can be designed as a programmable logic controller, as an industrial computer or the like and comprises computing means 6a as well as program and data memories, which are not illustrated, as is well known to those skilled in the art.

The transport device 2 comprises endlessly revolving conveying means 20, 21 which convey the pieces of tube 10 in the transport direction T at the transport speed V to the processing stations, 30, 40, . . . 80 after they have been transferred by the transfer device 4, wherein the pieces of tube 10 are oriented with their longitudinal direction L transversely to the transport direction T and with their front side edge 11 ahead. Tools processing the pieces of tube 10 are arranged in the processing stations 30, 40, . . . 80.

In this case, each conveying means 20, 21 comprises a transport chain 20a, 21a (alternatively a conveyor belt) and a metal belt 20b, 21b, which are arranged so as to lie on top of each other and endlessly revolve in opposite directions (see directional arrows k, 1), while forming a transport nip for the pieces of tube 10, with the transport chains 20a, 21a running below the metal belts 20b, 21b in the operating position of the plant.

On the transport chains 20a, 21a, retaining elements 22 in the form of oppositely polarized magnets are arranged at equal distances t from each other, which point in the direction of the metal belts 20b, 21b and attract the metal belts 20b, 21b, whereby the metal belts 20b, 21b attach themselves to the retaining elements 22 of the transport chains 20a, 21a and clamp the pieces of tube 10 between them, this being evident from FIG. 3, which constitutes a view of the transfer device 4 transversely to the transport direction T.

As an alternative to the configuration of the retaining elements 22 as magnets (permanent magnets), the retaining elements 22 can also be designed, for example, as suction cups, whereby the metal belts 20b, 21b can be omitted.

During processing at the various processing stations 30, 40, 50, 60, 70, 80, the pieces of tube 10 are continuously moved uniformly at the transport speed V and are not stopped. During transport, the conveying means 20, 21, in particular their retaining elements 22, always retain the pieces of tube 10 on the transport device 2 in the correct position. The retaining elements 22 are designed as discrete, that is individual elements.

To accomplish the transfer of the pieces of tube 10 from the transfer device 4 to the transport device 2, as already explained above, the grippers 4b attached to endless belts 4a revolving around pulleys 4c, 4d are arranged above the transport surface of the transport device 2, with the pulleys 4c, 4d being oriented in such a way that the endless belts 4a are oriented in parallel to the transport direction T of the conveying means 20, 21.

The grippers 4b always retract the next piece of tube 10 to be transferred from a storage surface 4f of the transfer device 4 until they are drawn into the transport nip by the conveying means 20, 21 and are transported in the correct position to the processing stations 30, 40 . . . 80 while being clamped by the retaining elements 22.

In this case, the rotational speed of the endless belts 4a from the first contact between the gripper 4b and a piece of tube 10 until the latter is released and drawn into the transport nip is synchronous with the conveying speed V. However, upon release of a piece of tube 10 until the contact between the gripper 4b and the subsequent piece of tube 10, a compensating movement of the endless belts 4a takes place with acceleration and deceleration phases in order to implement different system lengths SL or, respectively, in order to compensate for any slippage or manufacturing inaccuracies that occur. The system length SL is the width B of the pieces of tube 10 plus the distance A between the rear side edge 12 of a piece of tube 10 and the front side edge 11 of the subsequent piece of tube 10.

FIGS. 3, 4 and 5 show in detail the transfer process at three different times t₁, t₂ and t₃, wherein
at time t₁, the grippers 4b do not yet contact the piece of tube 10 to be transferred and still located on the storage surface 4f;
at time t₂, the grippers 4b press the piece of tube 10 to be transferred against a belt 4e of the transfer device 4, retract it from the storage surface 4f of the transfer device 4 in the conveying direction T and initiate the transfer to the conveying means 20, 21 in this manner;
at time t₃, the piece of tube 10 is already clamped between the retaining elements 22 and the metal belts 20b, 21b and the grippers 4b are again disengaged from the piece of tube 10.

The time interval between the contacting of a piece of tube 10 by the grippers 4b, the transfer of the piece of tube 10 to the conveying means 20, 21 and the contacting of the subsequent piece of tube 10 by the grippers 4b cannot thereby be reduced arbitrarily. Due to the design, the distance between successive pieces of tube 10 cannot therefore be less than a minimum distance Aₘᵢₙ between the rear side edge 12 of a piece of tube 10 and the front side edge 11 of the subsequent piece of tube 10, since the grippers 4b revolving on the endless belts 4a always require a certain amount of time until, after the transfer of a piece of tube 10 to the conveying means 20, 21, they are back in position for retracting the next piece of tube 10 from the storage surface 4f. Although this time can be shortened by providing several grippers 4b on the endless belts 4a, as is illustrated, and/or by increasing the rotational speed of the endless belts 4a, a certain minimum time period for positioning the grippers 4b is in any case required.

By the time the next piece of tube 10 can be transferred to the conveying means 20, 21, the piece of tube 10 previously transferred to the conveying means 20, 21 has already been carried away in the transport direction T at the transport speed V. For this reason, too, the resulting minimum distance Aₘᵢₙ between successive pieces of tube 10 cannot be fallen short of.

However, the minimum distance Aₘᵢₙ to be kept conforms not only with the limited dynamics of the transfer device 4, but also with the process-related processing times at the processing stations 30, 40, 50, 60, 70, 80 and the tools used there. Furthermore, the minimum distance Aₘᵢₙ to be kept also conforms with the bottom width of the bags to be produced and/or the length of the valve sheets 18.

Regardless of this, the device 1 for the production of cross-bottom bags from pieces of tube 10 also has a minimum system distance SLₘᵢₙ, which likewise depends on the limited dynamics of the transfer device, as well as on the process-related processing times at the processing stations 30, 40, 50, 60, 70, 80, e.g., on the welding speed during the production of the cross bottoms, but moreover also on the cycle rate and the resulting conveying speed V.

As mentioned above, the retaining elements 22 are consecutively arranged on the transport chains 20a, 21a at defined equal distances t in order to retain the front side edges 11 of the pieces of tube 10 during their transport. Such retaining elements 22 are indispensable at the desired high transport speeds, since, otherwise, the air resistance would move the pieces of tube 10 into indefinable positions or would partially bend them, the frictional resistance of the bag bodies 10 would furthermore increase in the bag conversion line during transport and, consequently, a production of high-quality cross bottoms would become impossible, or, respectively, the result would be machine shutdowns or even damage to the device 1. In this case, it is particularly important that the front side edges 11 of all transported pieces of tube 10 are arranged in a precisely defined geometric relation to the retaining elements 22 to make sure that the pieces of tube 10 are held firmly by the retaining elements 22. However, this means that the width B of the pieces of tube 10 and their mutual distance A on the transport device 2 cannot be chosen arbitrarily, since such an arbitrary change would inevitably also alter the position of the front side edge 11 of each piece of tube 10 in relation to the associated retaining elements 22. On the one hand, the effect could be that the front side edges 11 are gripped only partially by the retaining elements 22, which would be disastrous especially in case of suction cups, since a suction effect is no longer achievable. But also with other retaining elements, such as magnets, the fact that the front side area is gripped only partially and, as a result, the pieces of tube 10 are fixed insufficiently can cause them to be torn out of their clamping due to the frictional resistance during transport and processing and/or can cause a tilt (a skew position) of the magnets and consequently a decrease in the clamping force as a result of the support which is not over the entire surface. If, on the other hand, the freely made choice of the width B of the pieces of tube 10 and their mutual distance A causes the front side edges 11 of the pieces of tube to exceed a tolerable amount of projecting length U in the transport direction T relative to the retaining elements (and, if width B and distance A are freely chosen, this projecting length U can be between zero and the entire free path length between two adjacent retaining elements 22), the flatness of the piece of tube 10 becomes insufficient due to the large projecting length of the bag's front edge, whereby the frictional resistance during the transport and processing of the pieces of tube increases and the production of bags is disrupted. Large projecting lengths in combination with a lack of flatness and air resistance can cause pieces of tube 10 to get stuck on fixed guide elements or tools (e.g., folding and guide strips), to be bent over or to be displaced. In either case as described, geometrically correct processing of the pieces of tube 10 is not possible.

In FIG. 4, two sensors 25, 26 are schematically illustrated, which are arranged at a defined distance from each other, look at a straight strand of the transport chains 20a, 21a and measure the wear elongation thereof. Based on the measured wear elongation, the spacing t of the retaining elements 22, which is used for the calculation, is corrected, preferably by multiplying the predefined distance t between the retaining elements 22 by a correction factor corresponding to the wear elongation.

In the device 1 for the production of cross-bottom bags, there can also be processing elements in the processing stations 30, 40 . . . 80, which processing elements are also arranged at defined spatial distances from each other and operate in a timed manner. With all such processing elements, the freedom to select the width B of the pieces of tube 10 and their spacing A on the transport device 2 would likewise constitute a problem, because, of course, it is true also for such processing elements that the position of the front side edge 11 of each piece of tube 10 with respect to the processing elements changes depending on the setting of width B of the pieces of tube 10 and their distance A from each other.

In order to avoid the above-described problems which arise with a variation of the transfer and processing of the pieces of tube on the transport device with a distance A between the pieces of tube 10 that is independent of the width B of the pieces of tube 10, the present invention envisages that the distances A of successive pieces of tube 10 on the transport device 2 are adjusted depending on their width B in such a way or, respectively, only such distances A are allowed that the front side edges 11 of all pieces of tube 10 transported on the transport device 2 will assume an exactly defined geometric relation or, respectively, will always assume the same predetermined positions relative to the retaining elements 22 or the processing elements in the processing stations 30, 40 . . . 80 and will maintain so during the operation of the device 1. The defined geometric relation to the retaining elements 22 or the processing elements in the processing stations 30, 40 . . . 80 can preferably be a defined projecting length U. Alternatively, the defined geometric relation can be chosen such that the front side edges 11 of the pieces of tube 10 each coincide with the front ends of the retaining elements 22, or the retaining elements 22 with their surface operative for clamping pieces of tube 10 always rest on the pieces of tube 10 over their entire surface. In its implementation, this inventive idea requires that, in addition to the width B of the pieces of tube 10, the predetermined distance t between adjacent retaining elements 22 of the transport device 2 is taken into account as a parameter when determining permissible spacings A of successive pieces of tube 10. In this case, it is not planned for the distance A to be entered by an operator.

FIG. 6 schematically shows a top view of two pieces of tube 10 which move on the transport device 2 in the transport direction T at the transport speed V, thereby being retained by the retaining elements 22 which are mounted to the transport chains 20a, 21a and each have a distance t between each other. The pieces of tube 10 have a width B. The rear side edge 12 of the front piece of tube 10 is spaced from the front side edge 11 of the subsequent piece of tube 10 by a distance A. The front side edge 11 of the front piece of tube 10 protrudes by a projecting length U1 in relation to the frontmost retaining element 22 by which it is held. The front side edge 11 of the rear piece of tube 10 protrudes by a projecting length U2 in relation to the frontmost retaining element 22 by which it is held. Due to the measures according to the invention, it is ensured that the projecting lengths U1 and U2 are of the same size, i.e., U1=U2=U, which means that there is only one projecting length U for all pieces of tube 10 which is kept constant by adjusting the distance A between the pieces of tube 10, independently of the width B of the pieces of tube 10, as will be explained in further detail below:

In the course of the operation of the device 1 according to the invention, it may happen due to material stress and the resulting wear elongation of the conveying means 20, 21 that the spacing t of the retaining means 22 attached at the transport chains 20a, 21a changes. To ensure that the retaining elements of the transport chains 20a. 21a contact the pieces of tube 10 always at the same position with regard to the front side edge 11, e.g., with an adjustable projecting length U (see FIG. 5), independently of the tube width B, and draw them into the transport nip, a sensor 23 is furthermore provided, as can be seen in FIGS. 3 to 5, via which the positions of the retaining elements 22 can be detected directly or indirectly, for example via the position of the driven gear 24 of the chain guide of the transport chains 20a, 21a. The required offset of the grippers 4b is adjusted to this (e.g., by adjusting the rotational speed of the grippers 4b), and thus also the times at which they contact the pieces of tube 10 and initiate the transfer by retracting the pieces of tube 10 from the storage surface 4f.

The time at which the pieces of tube 10 are drawn into the transport nip and hence also the position of the front side edge 11 in geometric relation to the retaining elements 22 can thus be determined by the control unit 6 of the device 1.

Based on the above description of the device 1, the production of bags therefore takes place in the device 1 as follows:

At first, a storage facility S of the device 1 is loaded with a tube supply, e.g., a tube roll 10a of a certain width B.

Subsequently, the control unit 6 of the device 1 is informed of the width B of the tube roll 10a and thus of the cross-bottom bags to be produced via an input unit 5a, whereby this width B is determined for the batch to be produced from the tube roll 10a. For the reasons already described above, the device 1 only accepts widths that lie between a maximum and a minimum width which the device 1 is able to process. The limit values arise due to the design and can vary between bag conversion lines, but in finished bag conversion lines they are not amenable to change without complex modifications.

As an alternative to manually entering the width B, a sensor 5 for detecting the tube width B can be provided. This sensor 5 can also detect the minor fluctuations in the actual tube widths that occur in practice for production reasons (i.e., deviations from the entered nominal width). With the actual tube widths continuously detected by the sensor 5, the system length can then be calculated for each piece of tube as an integer multiple of the distance between the retaining elements. As a result, both production-related fluctuations in the actual tube width within a tube batch and a change in width during the exchange of the tube roll can be taken into account.

In a further step, the computing means 6a of the control unit 6 of the device 1 calculate the required system length SL while being aware of the specified tube width B and taking into account a construction or bag-related minimum distance Aₘᵢₙ in order to meet the condition of each piece of tube 10 being contacted by the retaining elements 22 at the same position in relation to its front side edge 11, independently of the tube width B, according to the following formula:

$$SL = max \{ t * [ int ( \frac{B + {A}_{min}}{t} ) + 1 ] ; {SL}_{min} \}$$

with
B width of a piece of tube
SL system length
Aₘᵢₙ minimum distance between the transported pieces of tube
SLₘᵢₙ minimum system length
t distance between adjacent retaining elements

wherein the following applies:
t, Aₘᵢₙ and SLₘᵢₙ are machine-specific and not adjustable by the user
A≥Aₘᵢₙ
SL≥SLₘᵢₙ
SL is divisible by t without remainder. The result is as follows: U1=U2=U.
SL is the smallest of all system lengths by which all the above-mentioned conditions are met.

Thus, the width B of the pieces of tube 10 and the minimum distance (Aₘᵢₙ) to be kept between successive pieces of tube 10 are first added together to form a temporary system length, and this temporary system length is divided by the defined distance t between the retaining elements 22. The division result is rounded up to the next higher integer by deleting the post-decimal point values of the division result and adding 1. The next higher integer determined in this way is multiplied by the defined distance t between the retaining elements 22, whereby the system length SL is obtained. The system length SL is compared with the predetermined minimum system length SLₘᵢₙ, and the larger one of the two values is established as the system length SL.

Table 1 below illustrates the system lengths SL calculated for different tube-piece widths B according to the above formula and the resulting distances A between the transported pieces of tube 10 for tube-piece widths B ranging from 260 mm to 570 mm, graded in increments of 5 mm, with a minimum bag distance Aₘᵢₙ of 35 mm, a nominal distance t between the retaining elements 22 of 31.75 mm, and a minimum system length SLₘᵢₙ of 444.5 mm, which corresponds to a number of 14 distances between the retaining elements 22. FIG. 7 shows a chart with the values determined in this way.

TABLE 1

| Tube | System | Bag |
|---|---|---|
| width | length | distance |
| B | SL | A |
| mm | mm | mm |
| 260 | 444.5 | 184.5 |
| 265 | 444.5 | 179.5 |
| 270 | 444.5 | 174.5 |
| 275 | 444.5 | 169.5 |
| 280 | 444.5 | 164.5 |
| 285 | 444.5 | 159.5 |
| 290 | 444.5 | 154.5 |
| 295 | 444.5 | 149.5 |
| 300 | 444.5 | 144.5 |
| 305 | 444.5 | 139.5 |
| 310 | 444.5 | 134.5 |
| 315 | 444.5 | 129.5 |
| 320 | 444.5 | 124.5 |
| 325 | 444.5 | 119.5 |
| 330 | 444.5 | 114.5 |
| 335 | 444.5 | 109.5 |
| 340 | 444.5 | 104.5 |
| 345 | 444.5 | 99.5 |
| 350 | 444.5 | 94.5 |
| 355 | 444.5 | 89.5 |
| 360 | 444.5 | 84.5 |
| 365 | 444.5 | 79.5 |
| 370 | 444.5 | 74.5 |
| 375 | 444.5 | 69.5 |
| 380 | 444.5 | 64.5 |
| 385 | 444.5 | 59.5 |
| 390 | 444.5 | 54.5 |
| 395 | 444.5 | 49.5 |
| 400 | 444.5 | 44.5 |
| 405 | 444.5 | 39.5 |
| 410 | 476.25 | 66.25 |
| 415 | 476.25 | 61.25 |
| 420 | 476.25 | 56.25 |
| 425 | 476.25 | 51.25 |
| 430 | 476.25 | 46.25 |
| 435 | 476.25 | 41.25 |
| 440 | 476.25 | 36.25 |
| 445 | 508 | 63 |
| 450 | 508 | 58 |
| 455 | 508 | 53 |
| 460 | 508 | 48 |
| 465 | 508 | 43 |
| 470 | 508 | 38 |
| 475 | 539.75 | 64.75 |
| 480 | 539.75 | 59.75 |
| 485 | 539.75 | 54.75 |
| 490 | 539.75 | 49.75 |
| 495 | 539.75 | 44.75 |
| 500 | 539.75 | 39.75 |
| 505 | 571.5 | 66.5 |
| 510 | 571.5 | 61.5 |
| 515 | 571.5 | 56.5 |
| 520 | 571.5 | 51.5 |
| 525 | 571.5 | 46.5 |
| 530 | 571.5 | 41.5 |
| 535 | 571.5 | 36.5 |
| 540 | 603.25 | 63.25 |
| 545 | 603.25 | 58.25 |
| 550 | 603.25 | 53.25 |
| 555 | 603.25 | 48.25 |
| 560 | 603.25 | 43.25 |
| 565 | 603.25 | 38.25 |
| 570 | 635 | 65 |

Taking into account a constant transport speed V, which essentially depends on the amount of work to be carried out at the processing stations 30, 40 . . . 80, the rotational speed of the grippers 4b is then determined while being aware of SL in order to accomplish the transfer of the pieces of tube 10 in accordance with the calculated system distance SL on the transport device 2.

After the tube supply, e.g., the tube roll 10a, has been used up, the storage facility S is loaded with a new tube supply, e.g., a new tube roll 10a, and the device 1 is ready to produce a new batch of cross-bottom bags.

The new tube supply can have the same width B as the previous batch. In this case, the device leaves the system length SL unchanged.

Alternatively, however, the new batch of cross-bottom bags can also be produced using a tube supply with a width B that is different from the width B of the first batch. After the new width B has been entered and established, the control unit 6 of the device 1 calculates, for this purpose, a new system length SL according to the above-indicated formula. Said new system length is then maintained until a batch again with a different tube width B is to be produced, etc.

1-18. (canceled)

19. A device for the production of bags from pieces of tube, comprising:
at least one transport device which transports the pieces of tube in a state of lying flat in a transport direction transversely to their longitudinal extension at a transport speed, with the pieces of tube passing through processing stations during their transport, by means of which at least one end region of each piece of tube is formed into a cross bottom,
a transfer device which transfers the pieces of tube consecutively to the transport device transversely to their longitudinal extension so that a rear side edge of one piece of tube is always at a distance from the front side edge of the subsequent piece of tube,
wherein,
the transport device includes at least one transport chain or a conveyor belt on which retaining elements are arranged at a defined distance from each other, and the distance between the pieces of tube is adjusted depending on a width of the pieces of tube and the defined spacing of the retaining elements such that, when viewed in the transport direction during the transport of the pieces of tube, the retaining elements assume the same predetermined positions relative to the front side edge of each piece of tube, independently of the width of the pieces of tube.

20. The device according to claim 19, further comprising a control for controlling the transfer device and for determining a system length, which is a sum of the width of a piece of tube and its distance from a subsequent piece of tube, wherein the control includes computing means that are configured to calculate the system length as an integer multiple of the defined distance between the retaining elements and, based on the calculated system length and the width of the pieces of tube, to adjust the distance at which the transfer device transfers the pieces of tube consecutively to the transport device.

21. The device according to claim 20, wherein the width of the pieces of tube can be supplied to the control manually via input means or automatically via a width sensor, or wherein the width of the pieces of tube is predefined in the control.

22. The device according to claim 20, wherein at least two sensors are provided which measure a wear elongation of the transport device or of the transport chains, and, based on the measured wear elongation, the spacing of the retaining elements is corrected, wherein the wear elongation is used for a calculation by multiplying the predefined distance between the retaining elements by a correction factor corresponding to the wear elongation.

23. The device according to claim 20, wherein the control is configured to determine the system length in such a way that a minimum distance (Aₘᵢₙ) between the successive pieces of tube is not fallen short of when they are transported on the transport device, said minimum distance (Aₘᵢₙ) being determinable via technical demands made on the device and/or via a desired bottom width of the bags to be produced and/or via the length of the valve sheets.

24. The device according to claim 20, wherein the computing means of the control are configured to calculate the system length as follows:
adding the width of the pieces of tube and a minimum distance (Aₘᵢₙ) to be maintained between successive pieces of tube to a temporary system length,
dividing the temporary system length by the defined distance between the retaining elements, and
rounding up the division result to the next higher integer and multiplying the next higher integer determined in this way by the defined distance between the retaining elements.

25. The device according to claim 24, wherein the computing means of the control are configured to compare the calculated system length with a minimum system length (SLₘᵢₙ) and, if the comparison shows that the system length is smaller than the minimum system length (SLₘᵢₙ), to establish the system length as the minimum system length (SLₘᵢₙ), with the minimum system length (SLₘᵢₙ) being an integer multiple of the defined distance between the retaining elements.

26. The device according to claim 20, wherein the width of the pieces of tube is adjustable in predefined increments.

27. A device for the production of bags from pieces of tube, comprising:
at least one transport device which transports the pieces of tube in a state of lying flat in a transport direction transversely to their longitudinal extension at a transport speed, with the pieces of tube passing through processing stations during their transport, by means of which at least one end region of each piece of tube is formed into a cross bottom,
a transfer device which transfers the pieces of tube consecutively to the transport device transversely to their longitudinal extension so that the rear side edge of one piece of tube is always at a distance from the front side edge of the subsequent piece of tube,
wherein,
at least one of the processing stations comprises processing elements which are arranged at defined distances from each other and operate in a timed manner synchronously with the transport speed, and a distance between the pieces of tube is adjusted depending on a width of the pieces of tube and the defined distance between the processing elements in such a way that, when viewed in the transport direction during the transport of the pieces of tube, the processing elements always assume the same predetermined positions relative to a front side edge of each piece of tube, independently of the width of the pieces of tube.

28. A method for the production of bags from pieces of tube,
wherein the pieces of tube are transported in a state of lying flat in a transport direction transversely to their longitudinal extension at a transport speed, wherein, at the pieces of tube during their transport, at least one end region of each piece of tube is formed into a cross bottom,
wherein the pieces of tube are transported transversely to their longitudinal extension in such a way that the rear side edge of one piece of tube is always at a distance from the front side edge of the subsequent piece of tube,
wherein
the pieces of tube are held during their transport by retaining elements which are arranged on at least one transport chain or a conveyor belt, the retaining elements being arranged at a defined distance from each other, and the distance between the pieces of tube is adjusted depending on a width of the pieces of tube and the defined spacing of the retaining elements in such a way that, when viewed in the transport direction during the transport of the pieces of tube, the retaining elements always assume the same predetermined positions relative to a front side edge of each piece of tube, independently of the width of the pieces of tube.

29. The method according to claim 28, wherein a system length is determined, which is the sum of the width of a piece of tube and its distance from the subsequent piece of tube, wherein the system length is calculated as an integer multiple of the defined distance between the retaining elements and, based on the calculated system length and the width of the pieces of tube, the distance is adjusted at which the pieces of tube are transported.

30. The method according to claim 28, wherein the width of the pieces of tube is detected manually via input means or automatically via a width sensor, or wherein the width of the pieces of tube is predefined.

31. The method according to claim 28, wherein a wear elongation of the transport device or of transport chains is measured and, based on the measured wear elongation, the spacing of the retaining elements, which is used for the calculation, is corrected by multiplying the predefined distance between the retaining elements by a correction factor corresponding to the wear elongation.

32. The method according to claim 28, wherein the system length is determined in such a way that a minimum distance (Aₘᵢₙ) between the successive pieces of tube is not fallen short of when they are transported, said minimum distance (Aₘᵢₙ) being determined via technical demands made on the device and/or via a desired bottom width of the bags to be produced and/or via the length of the valve sheets.

33. The method according to claim 28, wherein the system length is calculated as follows:
adding the width of the pieces of tube and a minimum distance (Aₘᵢₙ) to be maintained between successive pieces of tube to a temporary system length,
dividing the temporary system length by the defined distance between the retaining elements, and
rounding up the division result to the next higher integer and multiplying the next higher integer determined in this way by the defined distance between the retaining elements.

34. The method according to claim 33, wherein the calculated system length is compared with a minimum system length (SLₘᵢₙ) and, if the comparison shows that the system length is smaller than the minimum system length (SLₘᵢₙ), the system length is established as the minimum system length (SLₘᵢₙ), with the minimum system length (SLₘᵢₙ) being an integer multiple of the defined distance between the retaining elements.

35. The method according to claim 28, wherein the width of the pieces of tube is adjusted in predefined increments.

36. The method for the production of bags from pieces of tube, according to claim 29, wherein for the production of the cross bottoms, processing elements are provided which are arranged at defined distances from each other and operate in a timed manner synchronously with the transport speed, and the distance between the pieces of tube is adjusted depending on the width of the pieces of tube and the defined distance between the processing elements in such a way that, when viewed in the transport direction during the transport of the pieces of tube, the processing elements always assume the same predetermined positions relative to the front side edge of each piece of tube, independently of the width of the pieces of tube.
